(19) United States
(12) Patent Application Publication
(10) Pub. No.: US 2024/0061486 A1
(43) Pub. Date: Feb. 22, 2024

(54) CPU CENTRIC PLATFORM POWER MANAGEMENT AND CURRENT UNDER REPORTING DETECTION

(71) Applicants: Pavan Kumar, Portland, OR (US); Michael Zelikson, Haifa HA (IL); Kosta Luria, Pardesiya (IL); Robert Santucci, Gilbert, AZ (US); Nadav Shulman, Tel Mond M (IL); Horthense Tamdem, Portland, OR (US)

(72) Inventors: Pavan Kumar, Portland, OR (US); Michael Zelikson, Haifa HA (IL); Kosta Luria, Pardesiya (IL); Robert Santucci, Gilbert, AZ (US); Nadav Shulman, Tel Mond M (IL); Horthense Tamdem, Portland, OR (US)

(21) Appl. No.: 18/086,882

(22) Filed: Dec. 22, 2022

Related U.S. Application Data
(60) Provisional application No. 63/398,700, filed on Aug. 17, 2022.

(51) Int. Cl. G06F 1/28

(52) U.S. Cl. CPC G06F 1/28

(57) ABSTRACT

To address problems associated with power management of electronic devices, the subject matter described herein provides improved power management solutions that enable CPUs and other electronic components to characterize real-time power consumption. This may be used to assess an effect of added platform level features after factory testing, and may be used to improve or optimize system performance. These solutions may include an accurate platform-independent integrated voltage measurement, dedicated to a reliable absolute voltage measurement that may be used for multiple purposes. The subject matter described herein proposes a combination of a voltage detector and an algorithm implemented in the electronic component (e.g., CPU) that may be used to compensate for voltage variations due to tolerances or guard bands, and may be used to detect discrepancies of underreporting or overreporting of current information by the platform VR.

### PRIORITY

This application claims the benefit of priority to U.S. Patent Application Ser. No. 63/398,700, filed Aug. 17, 2022, which is incorporated by reference herein in its entirety.

### TECHNICAL FIELD

Embodiments described herein generally relate to power management for electronic devices (e.g., compute platforms).

### BACKGROUND

Power management of present-day compute platforms governs both component and platform levels as a whole. Power management may be affected by platform-specific features that manifest themselves after an electronic device component (e.g., central processing unit (CPU)) has been tested, characterized, and tuned. These effects that occur after a component has been tested, characterized, and tuned may lead to non-optimal platform performance, or even pose quality risks.

A CPU or other electronic component may use Dynamic Voltage and Frequency Scaling (DVFS) to provide frequency-dependent operating voltage settings. A voltage or frequency curve may be obtained as part of a product testing by a manufacturer (e.g., Intel, AMD) using its own test equipment. An electronic component may be integrated by an OEM, and may be combined with a third-party voltage regulator (VR). Each VR may have an associated voltage discrepancy between the requested and actual voltage levels. This voltage discrepancy may not match that of the tester VR, where the exact voltage value may vary among parts and operation conditions. The discrepancy between the required and actual voltage may lead to sub-optimal performance or a functional failure in the CPU or other electronic component.

Various Power Management (PM) schemes may be implemented on compute platforms to reduce power, maintain high performance, or limit thermal excursions. The type of PM scheme implemented depends on the specific platform requirement. Many PM schemes have some mechanism to measure or estimate the power consumption of the computing unit or the platform of interest. The accuracy of the power measurement technique may determine whether the compute unit component and electronic device as a whole is able to meet requirements associated with performance, performance per watt (Perf/W), and the Total Cost of Ownership (TCO). If the measured power is not accurate or if the measured power is deliberately manipulated higher or lower, the compute platform may not adhere to the specifications to which it is designed. Some Original Design Manufacturers (ODM) or Original Equipment Manufacturers (OEM) may manipulate the power consumption of the CPU by underreporting the current information Imon, such as to report better performance than is being realized at the ODM or OEM or as intended per the original design criteria.

Voltage accuracies due to design may be compensated by adding a voltage guard band (GB) (e.g., tolerance band (TOB)) to the voltage value requested by the CPU. However, even using a guard band, the current or power associated with an electronic device or component may be under-reported. Moreover, the TOB and current underreporting may not be related apparently. A TOB for a serial voltage identification (SVID) VR may be 35 mV. An application of TOB may manifest itself in increased power dissipation and consequent performance loss. This inaccurate monitoring of power consumption may result in variations of performance and Perf/W with a given CPU on various platforms, in CPUs operating at higher Thermal Design Power (TDP) than designed, and in reliability degradation (e.g., reduced warranties).

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating an example computing device with a CPU and a voltage regulator with power management features, according to an embodiment.

FIG. 2 is a block diagram illustrating the principle of a Current Under Reporting Detector (CUReD) approach, according to an embodiment.

FIG. 3 is a flowchart illustrating an example CUReD algorithm method, according to an embodiment.

FIG. 4 is a graph illustrating a CUReD example calculation using a reported Imon and measured Vout, according to an embodiment.

FIG. 5 is a block diagram illustrating an example CPU voltage sensor circuit, according to an embodiment.

FIG. 6 is a flowchart illustrating a method for current underreporting detection, according to an embodiment.

FIG. 7 is a block diagram of a computing device, according to an embodiment.

### DETAILED DESCRIPTION

In the following description, for purposes of explanation, numerous specific details are set forth to provide a thorough understanding of some example embodiments. It will be evident, however, to one skilled in the art that the present disclosure may be practiced without these specific details.

To address problems associated with power management of electronic devices, the subject matter described herein provides improved power management solutions that enable CPUs and other electronic components to operate with the least amount of guard band and characterize real-time power consumption. This may be used to assess an effect of added platform level features after factory testing, and may be used to improve or optimize system performance. These solutions may include an accurate platform-independent integrated voltage measurement, dedicated to a reliable absolute voltage measurement that may be used for multiple purposes.

The subject matter described herein proposes a combination of a voltage detector and an algorithm implemented in the electronic component (e.g., CPU) that may be used to compensate for voltage variations due to tolerances or guard bands, and may be used to detect discrepancies of underreporting or overreporting of current information by the platform VR. In this solution, the PM engine in the CPU can cross-reference the monitored voltage and use it to enable adjustments in PM operations, which may be used to detect and compensate for the difference between ideal (e.g., tester) case and the practical (e.g., platform) VR. This solution also provides a mechanism to detect and overcome deficiencies that exist in power telemetry used to determine the power consumption of the compute element. The solutions described herein include steps that may be taken to increase the accuracy of the power measurement and to detect violations of power consumption, which may be used to improve or optimize performance of a CPU or other compute device.

The improved power management solutions are described herein with respect to three parts. First, these solutions may include enablement of a reliable measurement of the absolute value of a Mother Board VR (MBVR) or Power Management IC (PMIC) output voltage in real time, along with filtering out load variations and related noise. Second, these solutions may include development of improved power management (PM) support, which may initiate MBVR calibration procedures and adjusts the effective MBVR output voltage to reduce associated guard bands. Third, these solutions may include detecting current underreporting by the VR that is supplying power to the compute unit (CPU). This may include determining whether a monitored current (e.g., Imon) as reported by a VR is accurate, which may be determined by measuring the output voltage of the VR and in conjunction with Automatic Voltage Positioning (AVP) feature to estimate the actual current consumed by the CPU.

These improved power management solutions may include reducing voltage guard bands and a Current Under Reporting Detector (CUReD). These solutions provide improved voltage determination at a voltage sense location used by MBVR (Voₛₑₙₛₑ). This sensed voltage is frequently dependent on the load current (Iout), given by:

Voₛₑₙₛₑ(t)=Vout_{MBVR}(t)−Iout(t)*LL+δVsense_{HF}

Vout_{MBVR}(t)=VID+Vᵣᵢₚₚₗₑ sin ωt

where Vout_{MBVR} is the voltage at the sense point under zero load conditions, LL is the value of the external load line setting, and Iout is the current consumed by the load from the VR. Iout is a low frequency (i.e., within MBVR bandwidth) portion of Iout(t). The contribution of the high frequency components of the load current is denoted by δV_{senseHF}. As this Vₛₑₙₛₑ component may be beyond the bandwidth of both tester VR and MBVR controllers, it may be excluded by averaging the voltage across multiple samples over time.

These solutions propose to implement a voltage meter inside the compute element. The integrated voltage meter may function within typical operating ranges, such as shown in Table 1:

TABLE 1
Typical Operating Ranges

| | |
|---|---|
| Voltage Measurement range | 0.35 V to 2 V |
| Supported Temperature | −10° C. to 110° C. (larger |
| | range may be needed for some products) |
| Measurement accuracy | 1 to 2.5 mV |
| Acquisition (capturing) time | ≤50 ns (generically adjusted to |
| | overcome anti-aliasing effects) |
| Voltage monitoring period | ≤10 s of μs |

These operating ranges may be implemented may be used for the reduction of the guard band and in the Current Under Reporting Detector (CUReD) solution. These operating ranges represent a realistic specification for an integrated voltage measurement gauge, relevant to modern CPUs in client or server applications. For a different electronic device, specifications of such integrated voltmeter may be different. In an example, a μ-ΣΔ architecture may be used in the design of a voltage measurement device, but other implementations may be used as well.

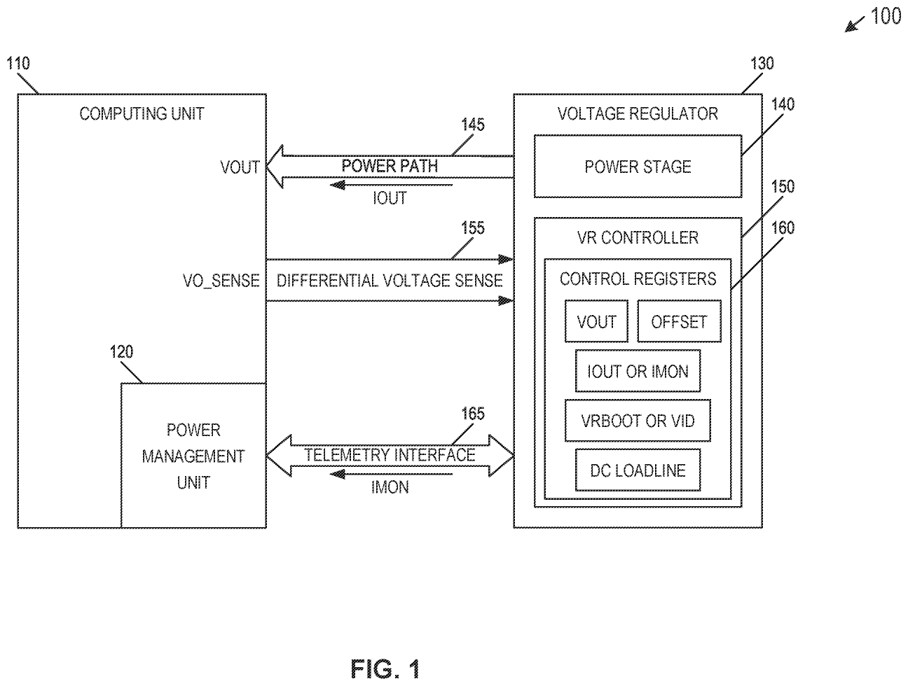

FIG. 1 is a block diagram illustrating an example computing device 100, according to an embodiment. Computing device 100 includes a computing unit 110 (e.g., central processing unit (CPU)) and a voltage regulator 130 (VR) with a power stage 140 to provide power management features. A VR controller 150 may be used to generate the output voltage (Vout) and provide Vout with associated output current (Iout) to the computing unit 110 via the power path 145. The VR controller 150 may control the generation of Vout (e.g., modulating voltage levels of Vout) based on one or more values within control registers 160. The computing unit 110 may sense a voltage V_{O_SENSE} within a voltage sensor within the computing unit 110, and provide V_{O_SENSE} to the voltage regulator 130 via a differential voltage sense path 155 from the computing unit 110. The voltage regulator 130 may be used to regulate Vout while delivering Iout, where the regulation may be based on a target output voltage. In addition, the VR controller 150 may define a monitored current Imon (e.g., the representation of Iout) and sends its value to the computing unit 110, such as via a telemetry interface 165 (e.g., Serial Voltage Identification (SVID) bus). The Imon data may be used by a power management unit 120 (PMU) within the computing unit 110 in its calculations.

If the current is being reported correctly, the current value reported by Imon should be substantially identical to that of Iout, which is used for the target voltage computation. However, when Imon values differs from the Iout value, then the actual Iout-based power dissipation Pout_{act} may be different from the estimated dissipated power (Poutₑₛₜ) by the voltage regulator 130 (based on Imon). Such a discrepancy may lead to unintended consequences. When Poutₑₛₜ<Pout_{act}, the power consumption is being underreported, and the computing unit 110 consumes more power than it estimates. This may enable higher performance of a platform, but may increase risks of functional failure, thermal stress, reliability reduction on the part, decreased performance per watt (e.g., Perf/W), and other risks. When Poutₑₛₜ>Pout_{act} the power consumption is being overreported, and the computing unit 110 can throttle prematurely, resulting in performance loss.

One improvement to power management may include reducing a voltage guard band. The minimal value of the output voltage provided by the mother board voltage regulator 130 may be assessed accurately, both in the test fixture and in a real system. A first method of assessing this output voltage may include using an existing V_{SENSE} point and performing a voltage measurement when the load current is reduced to its minimal value, followed by a reconstruction of min(V_{OUT_MBVR}), such as by PCode calculation. A second method of assessing this output voltage may include adding a dedicated test point connected to the measurement circuit only. These methods may be used individually or in combination. The first method may include more complex calibration and monitoring procedures, and may require intervention into natural CPU operation. The second method may enable simpler flows but may include changes to the compute platform, such as the addition of a measurement test point (e.g., measurement pin, measurement domain) and separate routing from the voltage regulator 130 to the new test point. If the existing V_{O_SENSE} is used, then prior to the measurement, the computing unit 110 may be instructed to enter an idle state and power off MBVR downstream voltage domains (e.g., as permitted by power management).

The reduction in voltage guard band may be realized in three steps, including a VR calibration within the manufacturing environment, a calibration outside the manufacturing environment (e.g., at an original equipment manufacturer (OEM) location), and an offset calculation based on the measurements taken within and outside the manufacturing environment.

First, for the calibration within the manufacturing environment, a CPU manufacturer (e.g., Intel) may calibrate a tester VR per voltage domain. This may include creating a mapping of SVID codes to readings of the voltage measurement gauge. For each SVID code, the readings are acquired over a period long enough to capture ripple-related changes in a tester VR output. A minimal value may then be determined, such as shown in Table 2:

TABLE 2
Minimal Value within Manufacturing Environment

| SVID tester | On-die Voltmeter minimal value |
|---|---|
| (000 . . . 0) | min{V_{on-die}(t)}_{@tester}_{_{—}}₀ |
| (000 . . . 1) | min{V_{on-die}(t)}_{@tester}_{_{—}}₁ |
| . . . | . . . |
| (111 . . . 1) | min{V_{on-die}(t)}_{@tester}_{_{—}}ₙ |

Second, for the calibration outside the manufacturing environment, once a motherboard (MB) integration is completed, a similar procedure is performed. Now the readings of the on-die voltmeter reflect the actual performance of the Mother Board Voltage Regulator (MBVR) mounted on the given mother board, such as shown in Table 3:

TABLE 3
Minimal Value outside Manufacturing Environment

| SVID MB | On-die Voltmeter minimal value |
|---|---|
| (000 . . . 0) | min{V_{on-die}(t)}_{@MBVR}_{_{—}}₀ |
| (000 . . . 1) | min{V_{on-die}(t)}_{@MBVR}_{_{—}}₁ |
| . . . | . . . |
| (111 . . . 1) | min{V_{on-die}(t)}_{@MBVR}_{_{—}}ₙ |

Third, an offset is calculated based on the measurements taken within and outside the manufacturing environment. A CPU may correlate OEM measurements and creates an offset mapping table for the on-die voltmeter readings in tester and MB environments. This may result in a respective SVID code mappings, such as the following: min{V_{on-die}(t)}_{@MBVR_i}≈min{V_{on-die}(t)}_{@tester_j}→{SVID_testerⱼ→VID_MBᵢ}. The tester2 MB SVID mapping table may be stored for future use, such as stored in BIOS. Whenever a CPU requests a certain SVID value, based on the test results, this value may be modified in accordance with the mapping table.

The MBVR output voltage behavior may be updated based on voltages that change over time (e.g., voltages dependent on temperature, component aging, power management policies). An on-die voltmeter may be used to monitor V_{out_MBVR} continually, and changes in its readings per the same SVID code may be factored by the power management unit in the frame of SVID calculation. The reduction in guardband may also enable reduction or elimination of other guardbands, such as guardbands due to aging.

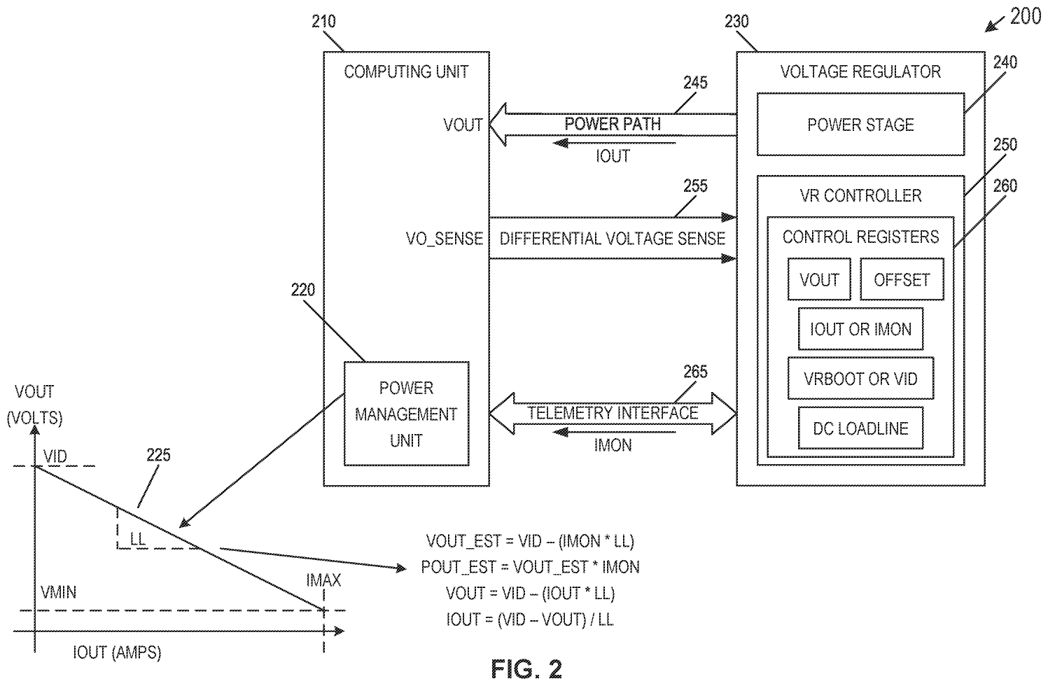

FIG. 2 is a block diagram illustrating the principle of a Current Under Reporting Detector (CUReD) approach 200, according to an embodiment. The CUReD approach 200 may be implemented using a computing unit 210 (e.g., CPU) with an integrated power management unit 220. The computing unit 210 may receive power along a power path 245 from a power stage 240 within a voltage regulator 230. The voltage regulator 230 may include a VR controller 250 that may control the generation of Vout based on one or more values within control registers 260 and based on a received differential voltage sense 255.

The CUReD approach 200 may be used to detect Imon underreporting by the telemetry interface 265 by measuring VR output voltage Vout from the power path 245. This may include determining a difference between the output voltage (Vout) observed or measured at the computing unit 210 and output voltage (Voutₑₛₜ) estimated by the power management unit 220 at any given current level. The CUReD approach 200 may estimate actual current consumed (Iout) by the integrated power management unit 220 based on the measured output voltage (Vout), and compare it to the reported current (Imon) to detect current under or over reporting by the voltage regulator 230.

As shown in FIG. 2, the VR supplies current Iout at a specified voltage Vout through the power path 245. The relationship between the delivered output voltage and the output current may be defined as Vout=VID−(Iout·LL), where Vout is the voltage at the computing unit 210 (e.g., within VR regulation bandwidth) for any given output current Iout. As shown in graph 225, the load line (LL) refers to the negative slope relationship between Iout and Vout, where VID refers to the initial set voltage at current=0.

The CUReD approach 200 may include measuring output voltage Vout. This may be accomplished by implementing a dedicated Analog to Digital Converter (ADC) on the computing unit 210, by reading (e.g., monitoring) output voltage reported via the telemetry interface 265 (e.g., Serial Voltage Identification (SVID) bus) and stored in the control registers 260, or by a dedicated voltage sensor (not shown) implemented on the motherboard.

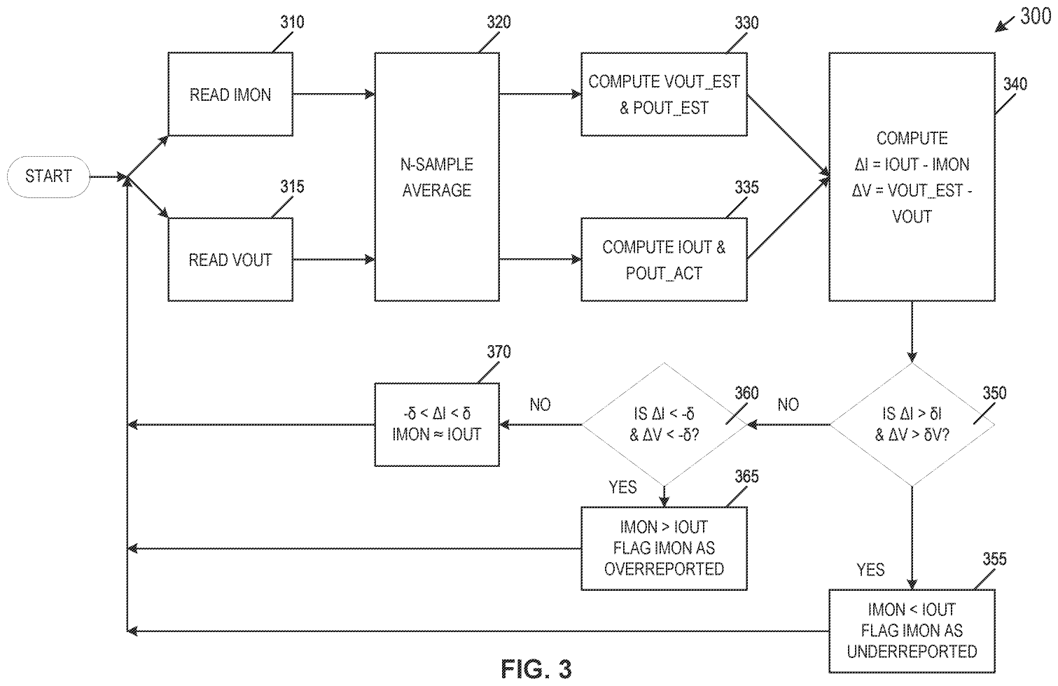

FIG. 3 is a flowchart illustrating an example CUReD algorithm method 300, according to an embodiment. CUReD algorithm method 300 shows a high-level flowchart for implementing an embodiment of the CUReD algorithm to detect underreporting or overreporting of Imon. While an OEM or OED may be more motivated to underreport Imon (e.g., to suggest better performance), the CUReD algorithm may be used in detecting underreporting and overreporting of Imon.

The CUReD algorithm method 300 may include reading Imon 310 and reading Vout 315, and taking an n-sample average 320 (e.g., moving window average) of current and voltage values. Based on the averaged current and voltage values, estimated voltage Voutₑₛₜ and power Poutₑₛₜ may be computed 330, where Voutₑₛₜ=VID−(I_{MON}*LL) and Poutₑₛₜ=(Voutₑₛₜ*I_{MON}). Also using the averaged current and voltage values, actual output current Iout and actual power output Pout_{act} may be computed 335, where Iout=(VID−Voutₑₛₜ)/LL and Pout_{act}=Vout*Iout.

The CUReD algorithm method 300 may include computing delta current ΔI and delta voltage ΔV values 340. The delta current ΔI may be computed as ΔI=(Iout−Imon), and the delta voltage ΔV may be computed as ΔV=(Voutₑₛₜ−Vout). The delta current ΔI and delta voltage ΔV values may then be compared against a delta current threshold value δI and delta voltage threshold value δV. When delta values exceed (e.g., transgress above) the corresponding thresholds 350 (e.g., both ΔI>δI and ΔV>δV), then CUReD algorithm method 300 may determine that Imon<Iout, and Imon may be flagged as underreporting the current 355. Similarly, when delta values are below (e.g., transgress below) the corresponding negative thresholds 360 (e.g., both ΔI<−δI and ΔV<−δV), then CUReD algorithm method 300 may determine that Imon>Iout, and Imon may be flagged as overreporting the current 365. If Imon is neither underreported nor overreported (e.g., −δI<ΔI<δI), then CUReD algorithm method 300 may determine that Imon≈Iout 370, and no underreporting or overreporting flag may be set.

In CUReD algorithm method 300, initially a stable or standard workload may be identified and run on a server platform. While the workload does not need to be controlled or calibrated, a relatively steady CPU-initiated workload with less transient activity may be used to provide improved accuracy in Imon analysis, such as to determine values for δI and δV. Each δI and δV may be calculated to allow for some fluctuation in current and voltage values (e.g., a tolerance), while providing a threshold beyond which the system may be determined to be underreporting or overreporting current or voltage values. The workload may include a known training algorithm, which may be initiated at the beginning of a boot cycle. In an example, the workload may include a server with one or more processors turned on (e.g., processor c-state of C0, processor c-state of C6 disabled) may provide an increased current draw for the Imon analysis. The workload may be used to provide a substantially constant load to the VR, which improves the accuracy of the measurement of the voltage, and will result in increased accuracy of averaging effects over a given period. The accuracy of the CUReD algorithm method 300 may be improved further when workload is well-known, controlled, and substantially steady (e.g., reduced or minimized transient activity) over a given period. Such workloads may be initiated on a typical computing platform, such as using a Power Management Unit (PMU).

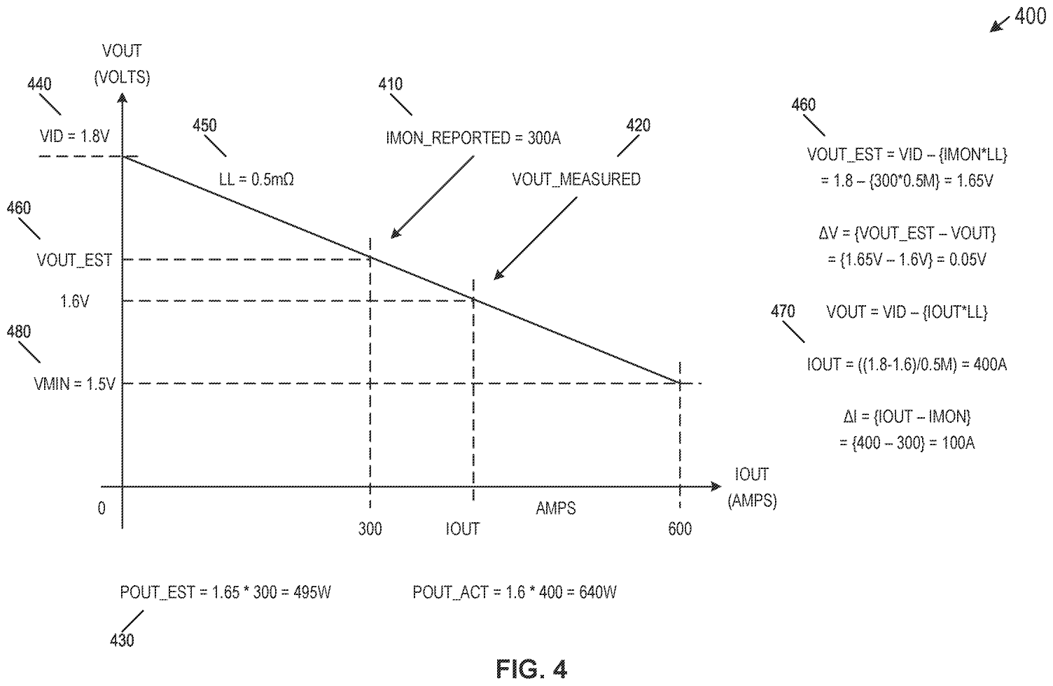

FIG. 4 is a graph illustrating a CUReD example calculation 400, according to an embodiment. The CUReD example calculation 400 may be based on an analysis of reported Imon 410 and measured Vout 420. A PMU may use Imon 410 information to estimate the power consumed Poutₑₛₜ 430 by the CPU. Because initial set voltage VID 440 and LL 450 are substantially fixed, Voutₑₛₜ 460 may be computed using Imon 410 as reported by the VR. By monitoring Imon 410 while measuring Vout 420, the actual current Iout 470 may be estimated more accurately using the same LL concept to detect the difference between the two values.

CUReD example calculation 400 shows an example of how the proposed CUReD methodology may be used to detect the underreporting of Imon 410. VID 440 may be treated as substantially fixed parameters for a given VR and given design. As shown the CUReD example calculation 400, VID=1.8V, and LL=0.5 mΩ. In addition, the maximum current of the VR may be known and substantially constant (e.g., 600 A) as defined the capacity of the VR. The LL 450 may be derived using the linear relation with a negative slope of 0.5 mΩ as shown, resulting in a minimum voltage Vmin 480, where Vmin=1.5V. For a given current Imon 410 of 300 A reported via the telemetry interface, the estimated voltage Voutₑₛₜ 460 and corresponding power Poutₑₛₜ 430 may be determined by the PMU as 1.65V and 495 W, respectively. To determine whether the reported Imon 410 is indeed correct, the actual output voltage Vout 420 may be measured (e.g., 1.6V in this case). Using the same linear relation, the actual current being consumed by the CPU may be determined using only Vout 420 information, such as Iout=400 A and power consumption Pout_{act}=640 W. The difference between Iout 470 and Imon 410, and correspondingly between Voutₑₛₜ 460 and measured Vout 420, may be used to detect discrepancies and underreporting of the current.

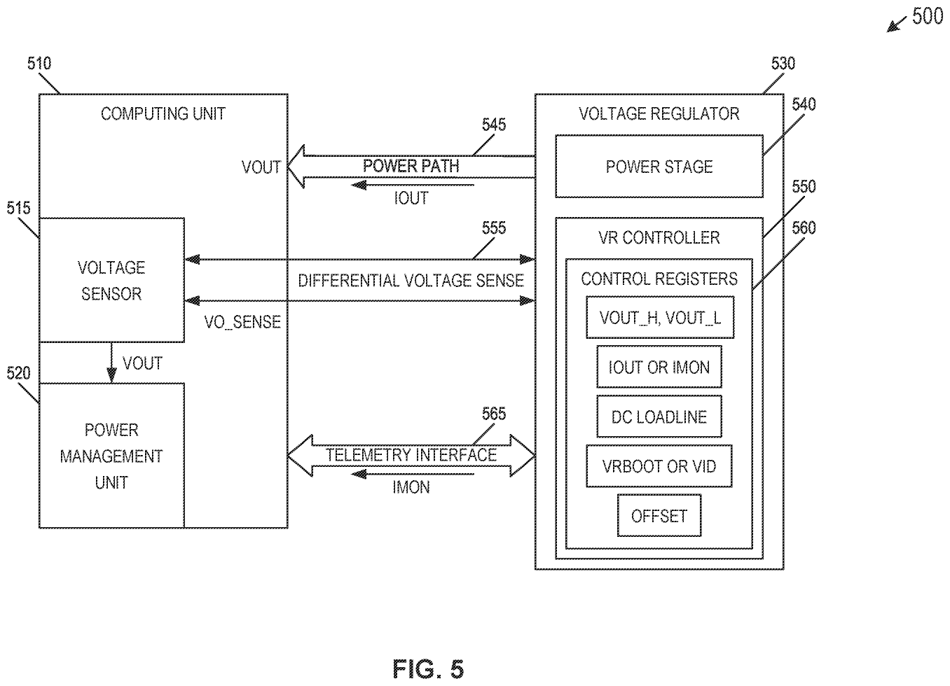

FIG. 5 is a block diagram illustrating an example CPU voltage sensor circuit 500, according to an embodiment. The CPU voltage sensor circuit 500 may be implemented using a computing unit 510 (e.g., CPU) with an integrated power management unit 520. The computing unit 510 may receive power along a power path 545 from a power stage 540 within a voltage regulator 530. The voltage regulator 530 may include a VR controller 550 that may control the generation of Vout based on one or more values within control registers 560 and based on a received differential voltage sense 555.

The CPU voltage sensor circuit 500 shows various options for measuring the output voltage Vout. In an example, the control registers 560 may include a Vout register, which may measure and record Vout. When measuring Vout via SVID from VR controller 550, each VR controller 550 may have a set of control registers 560 that monitor key VR parameters (e.g., output voltage Vout) and stores these parameters in particular registers. The Vout information, when available and supported in the VR controller 550, may be read by the integrated power management unit 520 via telemetry interface 565. While measuring Vout within the voltage regulator 530 is a straightforward way to implement CUReD, the validity of the data obtained from the VR controller 550 may be manipulated by an external source. Voltage output Vout information cannot be easily scaled or manipulated in the VR controller register 560, because computing unit 510 would stop working if scaled beyond a small value around the expected value. This characteristic may be used to improve or maximize accuracy of the voltage reading.

In another example, Vout may be measured using a voltage sensor 515 within the computing unit 510, and Vout may then be provided to the integrated power management unit 520. When measuring Vout internal to computing unit 510, a voltage sensor within the computing unit 510 may provide improved data validity and security. An additional measurement (e.g., SVID measurement) may be used to determine and provide a correction for (e.g., calibrate-out) a MBVR DC positioning error. The integrated power management unit 520 may obtain the Vout information to determine the corresponding Iout. The on-die voltage sensor 515 may provide improved coherency on part of Vout and Imon sampling, resulting in higher accuracy. Additionally, various averaging techniques may be used either in a short time frame (e.g., tens of μs) when transient activity is frequent or high or over longer period of time (e.g., tens of msec). The on-die voltage sensor 515 device may be designed to support simultaneous sampling between voltage and current.

In another example, Vout may be measured using a voltage sensor mounted on the motherboard and external to the computing unit 510 and the voltage regulator 530 (not shown). Implementing a voltage sensor on the motherboard may incur additional cost and may include separate interface, such as to communicate the voltage information to the integrated power management unit 520 in the computing unit 510. However, this implementation will also provide improved Vout and Imon sampling, and reduce or eliminate misreporting issues caused by scaled or manipulated Vout or Imon values within the VR controller register 560.

Additional analysis maybe used to confirm LL information that read from the VR controller 550 matches that of the fused values inside the computing unit 510, such as to detect if current or voltage manipulation has occurred. The proposed CUReD algorithm may be implemented in a computing unit 510 or in one or more other computing elements. In some examples, CUReD may be implemented in a platform Base Management Controller (BMC), in a Basic Input Output System (BIOS), in a platform integrated power management unit 520, or in another computing element. The computing element used by CUReD may provide the Imon value from a VR controller 550 (e.g., with LL or AVP implemented), which may be used to determine the output voltage Vout of the VR of interest.

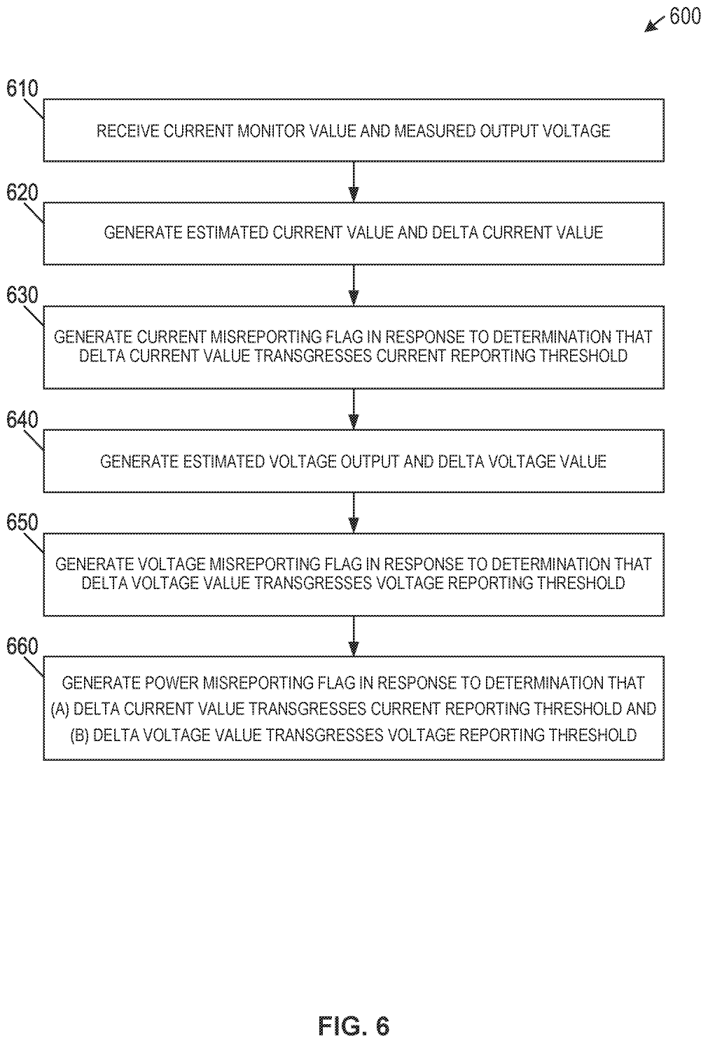

FIG. 6 is a flowchart illustrating a method for current underreporting detection 600, according to an embodiment. At step 610, method 600 includes receiving a current monitor value and a measured output voltage. The current monitor value may be received from a voltage regulator controller at a power management unit within a processor. At step 620, method 600 includes generating an estimated current value based on the measured output voltage, generating a delta current value based on a difference between the estimated current value and the current monitor value. At step 630, method 600 includes generating a current misreporting flag in response to a determination that the delta current value transgresses a current reporting threshold.

At step 640, method 600 may also include generating an estimated voltage output based on the current monitor value, generating a delta voltage value based on a difference between the estimated voltage output and the measured output voltage. At step 650, method 600 may also include generating a voltage misreporting flag in response to a determination that the delta voltage value transgresses a voltage reporting threshold. At step 660, method 600 may also include generating a power misreporting flag in response to a determination that both (A) the delta current value transgresses the current reporting threshold and (B) the delta voltage value transgresses the voltage reporting threshold.

The estimated voltage output may be generated based on a difference between an initial set voltage and a voltage product, where the voltage product includes a product of the current monitor value and a processor load line. The delta current value may be generated based on a current difference between the estimated current value and a multiple current sample average, where the multiple current sample average is generated based on a plurality of current values received from the voltage regulator controller.

The delta voltage value is based on a voltage difference between a multiple voltage sample average and the measured output voltage, where the multiple voltage sample average is generated based on a plurality of voltage values. The measured output voltage may be generated at the voltage sensor based on a differential voltage sense received from a voltage regulator circuit at a voltage sensor within the processor. The measured output voltage may be received at the power management unit from a voltage output register within the voltage regulator controller.

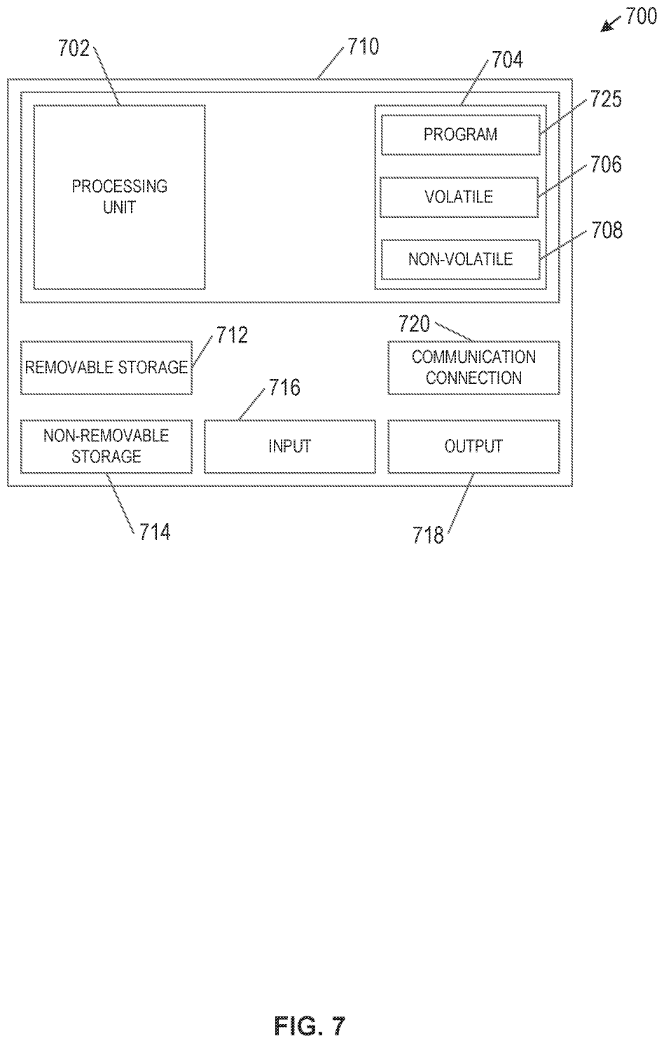

FIG. 7 is a block diagram of a computing device 700, according to an embodiment. The performance of one or more components within computing device 700 may be improved by including one or more of the circuits or circuitry methods described herein. Computing device 700 may include a first differential pair amplifier circuit including a first transistor and a second transistor. The first transistor may be used to receive a first amplified victim signal at a first transistor source node, receive an aggressor signal at a first transistor gate node, and generate a first cancellation pulse to cancel a first crosstalk pulse in the first amplified victim signal. The second transistor may be used to receive a second amplified victim signal at a second transistor source node, receive a voltage reference signal at a second transistor gate node, and generate a second cancellation pulse to cancel a second crosstalk pulse in the second amplified victim signal.

In one embodiment, multiple such computer systems are used in a distributed network to implement multiple components in a transaction-based environment. An object-oriented, service-oriented, or other architecture may be used to implement such functions and communicate between the multiple systems and components. In some embodiments, the computing device of FIG. 7 is an example of a client device that may invoke methods described herein over a network. In some embodiments, the computing device of FIG. 7 is an example of one or more of the personal computer, smartphone, tablet, or various servers.

One example computing device in the form of a computer 710, may include a processing unit 702, memory 704, removable storage 712, and non-removable storage 714. Although the example computing device is illustrated and described as computer 710, the computing device may be in different forms in different embodiments. For example, the computing device may instead be a smartphone, a tablet, or other computing device including the same or similar elements as illustrated and described with regard to FIG. 7. Further, although the various data storage elements are illustrated as part of the computer 710, the storage may include cloud-based storage accessible via a network, such as the Internet.

Returning to the computer 710, memory 704 may include volatile memory 706 and non-volatile memory 708. Computer 710 may include or have access to a computing environment that includes a variety of computer-readable media, such as volatile memory 706 and non-volatile memory 708, removable storage 712 and non-removable storage 714. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 710 may include or have access to a computing environment that includes input 716, output 718, and a communication connection 720. The input 716 may include one or more of a touchscreen, touchpad, mouse, keyboard, camera, and other input devices. The input 716 may include a navigation sensor input, such as a GNSS receiver, a SOP receiver, an inertial sensor (e.g., accelerometers, gyroscopes), a local ranging sensor (e.g., LIDAR), an optical sensor (e.g., cameras), or other sensors. The computer may operate in a networked environment using a communication connection 720 to connect to one or more remote computers, such as database servers, web servers, and another computing device. An example remote computer may include a personal computer (PC), server, router, network PC, a peer device or other common network node, or the like. The communication connection 720 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 702 of the computer 710. A hard drive (magnetic disk or solid state), CD-ROM, and RAM are some examples of articles including a non-transitory computer-readable medium. For example, various computer programs 725 or apps, such as one or more applications and modules implementing one or more of the methods illustrated and described herein or an app or application that executes on a mobile device or is accessible via a web browser, may be stored on a non-transitory computer-readable medium.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Example 1 is a system comprising: a voltage regulator controller to: receive a voltage identification from a processor; and retrieve a circuit board processor voltage value associated with the voltage identification from a voltage offset mapping table, the voltage offset mapping table mapping a plurality of tester voltage values to a plurality of circuit board processor voltage values; and a voltage regulator power stage to provide a processor voltage to the processor based on the circuit board processor voltage value.

In Example 2, the subject matter of Example 1 includes wherein: the plurality of tester voltage values was mapped to a plurality of voltage identification values prior to the processor being integrated into a circuit board.

In Example 3, the subject matter of Examples 1-2 includes wherein the voltage offset mapping table provides a more accurate mapping of the voltage identification to the plurality of tester voltage values to reduce a voltage guard band.

In Example 4, the subject matter of Examples 1-3 includes wherein the voltage offset mapping table is loaded from a basic input output system into the voltage regulator controller.

In Example 5, the subject matter of Examples 1-4 includes wherein the plurality of tester voltage values and the plurality of circuit board processor voltage values are received at the voltage regulator controller from the processor.

In Example 6, the subject matter of Examples 1-5 includes wherein the plurality of tester voltage values and the plurality of circuit board processor voltage values are measured when the processor is in an idle state.

In Example 7, the subject matter of Examples 1-6 includes a dedicated voltage test point conductively coupled to the voltage regulator power stage, wherein the plurality of tester voltage values and the plurality of circuit board processor voltage values are measured at the dedicated voltage test point.

In Example 8, the subject matter of Examples 1-7 includes wherein the voltage identification includes a serial voltage identification (SVID) value generated by the processor.

In Example 9, the subject matter of Examples 1-8 includes wherein: the circuit board includes a motherboard; and the processor is disposed on the motherboard.

Example 10 is a method comprising: receiving a current monitor value from a voltage regulator controller at a power management unit within a processor; receiving a measured output voltage; generating an estimated current value based on the measured output voltage; generating a delta current value based on a difference between the estimated current value and the current monitor value; and generating a current misreporting flag in response to a determination that the delta current value transgresses a current reporting threshold.

In Example 11, the subject matter of Example 10 includes the method further including: generating an estimated voltage output based on the current monitor value; generating a delta voltage value based on a difference between the estimated voltage output and the measured output voltage; and generating a voltage misreporting flag in response to a determination that the delta current value transgresses a voltage reporting threshold.

In Example 12, the subject matter of Example 11 includes the method further including generating a voltage product of the current monitor value and a processor load line, wherein the estimated voltage output is based on a difference between an initial set voltage and the voltage product.

In Example 13, the subject matter of Examples 11-12 includes the method further including generating a power misreporting flag in response to a determination that the delta current value transgresses the current reporting threshold and the delta voltage value transgresses the voltage reporting threshold.

In Example 14, the subject matter of Examples 10-13 includes the method further including: receiving a plurality of current values from the voltage regulator controller; and generating a multiple current sample average based on the plurality of current values; wherein the delta current value is based on a current difference between the estimated current value and the multiple current sample average.

In Example 15, the subject matter of Examples 11-14 includes the method further including: receiving a plurality of voltage values; and generating a multiple voltage sample average based on the plurality of voltage values; wherein the delta voltage value is based on a voltage difference between the multiple voltage sample average and the measured output voltage.

In Example 16, the subject matter of Examples 10-15 includes the method further including: providing a differential voltage sense to a voltage regulator circuit from a voltage sensor within the processor; and generating the measured output voltage at the voltage sensor based on the differential voltage sense.

In Example 17, the subject matter of Examples 10-16 includes the method further including receiving the measured output voltage at the power management unit from a voltage output register within the voltage regulator controller.

Example 18 is a system comprising: a voltage regulator circuit including a power stage and a voltage regulator controller; and a processor including a power management unit, the power management unit to: receive a current monitor value from the voltage regulator controller; receive a measured output voltage; generate an estimated current value based on the measured output voltage; generate a delta current value based on a difference between the estimated current value and the current monitor value; and generate a current misreporting flag in response to a determination that the delta current value transgresses a current reporting threshold.

In Example 19, the subject matter of Example 18 includes the power management unit further to: generate an estimated voltage output based on the current monitor value; generate a delta voltage value based on a difference between the estimated voltage output and the measured output voltage; and generate a voltage misreporting flag in response to a determination that the delta current value transgresses a voltage reporting threshold.

In Example 20, the subject matter of Example 19 includes the power management unit further to generate a voltage product of the current monitor value and a processor load line, wherein the estimated voltage output is based on a difference between an initial set voltage and the voltage product.

In Example 21, the subject matter of Examples 19-20 includes the power management unit further to generate a power misreporting flag in response to a determination that the delta current value transgresses the current reporting threshold and the delta voltage value transgresses the voltage reporting threshold.

In Example 22, the subject matter of Examples 18-21 includes the power management unit further to: receive a plurality of current values from the voltage regulator controller; and generate a multiple current sample average based on the plurality of current values; wherein the delta current value is based on a current difference between the estimated current value and the multiple current sample average.

In Example 23, the subject matter of Examples 19-22 includes the power management unit further to: receive a plurality of voltage values; and generate a multiple voltage sample average based on the plurality of voltage values; wherein the delta voltage value is based on a voltage difference between the multiple voltage sample average and the measured output voltage.

In Example 24, the subject matter of Examples 18-23 includes the processor further including a voltage sensor, the voltage sensor to provide a differential voltage sense to the voltage regulator circuit and generate the measured output voltage.

In Example 25, the subject matter of Examples 18-24 includes the voltage regulator controller including a voltage output register, wherein the measured output voltage is received at the power management unit from the voltage output register.

Example 26 is at least one machine-readable medium including instructions that, when executed by processing circuitry, cause the processing circuitry to perform operations to implement of any of Examples 1-25.

Example 27 is an apparatus comprising means to implement of any of Examples 1-25.

Example 28 is a system to implement of any of Examples 1-25.

Example 29 is a method to implement of any of Examples 1-25.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system comprising:
a voltage regulator controller to:
receive a voltage identification from a processor; and
retrieve a circuit board processor voltage value associated with the voltage identification from a voltage offset mapping table, the voltage offset mapping table mapping a plurality of tester voltage values to a plurality of circuit board processor voltage values; and
a voltage regulator power stage to provide a processor voltage to the processor based on the circuit board processor voltage value.

2. The system of claim 1, wherein:
the plurality of tester voltage values was mapped to a plurality of voltage identification values prior to the processor being integrated into a circuit board.

3. The system of claim 1, wherein the voltage offset mapping table provides a more accurate mapping of the voltage identification to the plurality of tester voltage values to reduce a voltage guard band.

4. The system of claim 1, wherein the voltage offset mapping table is loaded from a basic input output system into the voltage regulator controller.

5. The system of claim 1, wherein the plurality of tester voltage values and the plurality of circuit board processor voltage values are received at the voltage regulator controller from the processor.

6. The system of claim 1, wherein the plurality of tester voltage values and the plurality of circuit board processor voltage values are measured when the processor is in an idle state.

7. The system of claim 1, further including a dedicated voltage test point conductively coupled to the voltage regulator power stage, wherein the plurality of tester voltage values and the plurality of circuit board processor voltage values are measured at the dedicated voltage test point.

8. The system of claim 1, wherein the voltage identification includes a serial voltage identification (SVID) value generated by the processor.

9. The system of claim 1, wherein:
the circuit board includes a motherboard; and
the processor is disposed on the motherboard.

10. A method comprising:
receiving a current monitor value from a voltage regulator controller at a power management unit within a processor;
receiving a measured output voltage;
generating an estimated current value based on the measured output voltage;
generating a delta current value based on a difference between the estimated current value and the current monitor value; and
generating a current misreporting flag in response to a determination that the delta current value transgresses a current reporting threshold.

11. The method of claim 10, the method further including:
generating an estimated voltage output based on the current monitor value;
generating a delta voltage value based on a difference between the estimated voltage output and the measured output voltage; and
generating a voltage misreporting flag in response to a determination that the delta current value transgresses a voltage reporting threshold.

12. The method of claim 11, the method further including generating a voltage product of the current monitor value and a processor load line, wherein the estimated voltage output is based on a difference between an initial set voltage and the voltage product.

13. The method of claim 11, the method further including generating a power misreporting flag in response to a determination that the delta current value transgresses the current reporting threshold and the delta voltage value transgresses the voltage reporting threshold.

14. The method of claim 10, the method further including:
receiving a plurality of current values from the voltage regulator controller; and
generating a multiple current sample average based on the plurality of current values;
wherein the delta current value is based on a current difference between the estimated current value and the multiple current sample average.

15. The method of claim 11, the method further including:
receiving a plurality of voltage values; and
generating a multiple voltage sample average based on the plurality of voltage values;
wherein the delta voltage value is based on a voltage difference between the multiple voltage sample average and the measured output voltage.

16. The method of claim 10, the method further including:
providing a differential voltage sense to a voltage regulator circuit from a voltage sensor within the processor; and
generating the measured output voltage at the voltage sensor based on the differential voltage sense.

17. The method of claim 10, the method further including receiving the measured output voltage at the power management unit from a voltage output register within the voltage regulator controller.

18. A system comprising:
a voltage regulator circuit including a power stage and a voltage regulator controller; and
a processor including a power management unit, the power management unit to:
receive a current monitor value from the voltage regulator controller;
receive a measured output voltage;
generate an estimated current value based on the measured output voltage;
generate a delta current value based on a difference between the estimated current value and the current monitor value; and
generate a current misreporting flag in response to a determination that the delta current value transgresses a current reporting threshold.

19. The system of claim 18, the power management unit further to:
generate an estimated voltage output based on the current monitor value;
generate a delta voltage value based on a difference between the estimated voltage output and the measured output voltage; and
generate a voltage misreporting flag in response to a determination that the delta current value transgresses a voltage reporting threshold.

20. The system of claim 19, the power management unit further to generate a voltage product of the current monitor value and a processor load line, wherein the estimated voltage output is based on a difference between an initial set voltage and the voltage product.

21. The system of claim 19, the power management unit further to generate a power misreporting flag in response to a determination that the delta current value transgresses the current reporting threshold and the delta voltage value transgresses the voltage reporting threshold.

22. The system of claim 18, the power management unit further to:
receive a plurality of current values from the voltage regulator controller; and
generate a multiple current sample average based on the plurality of current values;
wherein the delta current value is based on a current difference between the estimated current value and the multiple current sample average.

23. The system of claim 19, the power management unit further to:
receive a plurality of voltage values; and
generate a multiple voltage sample average based on the plurality of voltage values;
wherein the delta voltage value is based on a voltage difference between the multiple voltage sample average and the measured output voltage.

24. The system of claim 18, the processor further including a voltage sensor, the voltage sensor to provide a differential voltage sense to the voltage regulator circuit and generate the measured output voltage.

25. The system of claim 18, the voltage regulator controller including a voltage output register, wherein the measured output voltage is received at the power management unit from the voltage output register.
